(19) United States
(12) Patent Application Publication
(10) Pub. No.: US 2022/0408958 A1
(43) Pub. Date: Dec. 29, 2022

(54) MOTORIZED DRIVE DEVICE OF AN OCCULTATION OR SOLAR PROTECTION DEVICE, OCCULTATION OR SOLAR PROTECTION DEVICE AND ASSOCIATED INSTALLATION

(71) Applicant: SOMFY ACTIVITES SA, Cluses (FR)

(72) Inventors: Norbert DUPIELET, Cluses (FR); Eric LAGARDE, Cluses (FR); Rémi SOURAIN, Cluses (FR)

(21) Appl. No.: 17/780,920

(22) PCT Filed: Nov. 27, 2020
(86) PCT No.: PCT/EP2020/083571

§ 371 Date: May 27, 2022

(30) Foreign Application Priority Data
Nov. 29, 2019 (FR) FR1913485

(51) Int. Cl. A47H 5/02; A47H 1/06

(52) U.S. Cl. CPC A47H 5/02; A47H 1/06; A47H 2005/025

(57) ABSTRACT

A motorized drive device includes a housing, electric motor, drive wheel, first and second holding devices, first elastic return element, drive unit inside the housing, and switching mechanism. The drive unit includes a casing, the electric motor and the drive wheel. The drive wheel is supported on a rail running surface, by the first elastic return element. With the motor activated, the casing inclines inside the housing relative to a median plane of the housing. The switching mechanism drives a first guide wheel of the first holding device between first and second positions, in which the motorized drive device is mounted and dismounted, respectively, relative to the rail. In the first position with the electric motor activated, the drive wheel is supported on the rail running surface, by the first elastic return element which is supported on a wall in the housing and is rotated by the electric motor.

### CROSS-REFERENCE TO RELATED APPLICATIONS

This application is the U.S. national phase of International Application No. PCT/EP2020/083571 filed Nov. 27, 2020 which designated the U.S. and claims priority to FR 1913485 filed Nov. 29, 2019, the entire contents of each of which are hereby incorporated by reference.

### BACKGROUND OF THE INVENTION

### Field of the Invention

The present invention relates to a motorized drive device of an occultation or solar protection device, provided to move at least one screen along a rail following a sliding movement.

The present invention also relates to an occultation or solar protection device equipped with such a motorized drive device, as well as a home automation installation comprising such an occultation or solar protection device.

The present invention relates generally to the field of curtains comprising a motorized drive device that moves a screen in a sliding movement relative to a rail, between at least a first position and at least a second position.

### Description of the Related Art

Document WO 2012/004530 A1 is already known to describe a motorized drive device of an occultation or solar protection device. The motorized drive device comprises a housing, an electric motor, a drive wheel, a first holding device, a second holding device and an elastic return element. The drive wheel is configured to be rotated by the electric motor and to be supported on at least one running surface of a rail of the occultation or solar protection device, so as to move the motorized drive device along the rail in a direction of travel. The first holding device includes a first guide wheel and a second guide wheel. The first and second guide wheels are configured to engage a first and second running track of the rail, respectively. The second holding device comprises a first guide wheel and a second guide wheel. The first and second guide wheels are configured to engage the first and second running tracks of the rail, respectively.

This motorized drive device is satisfactory in general. However, this motorized drive device has the disadvantage of having the elastic return element at either first or second holding devices and, more particularly, between the housing and a nut screwed onto a threaded portion of an arm of the second holding device.

Thus, when the electric motor is electrically activated, the housing pivots about an axis of rotation of the first and second guide wheels of the first holding device.

In this way, when the electric motor is electrically activated, the housing is moved more or less away from the rail at one of its ends.

The pivoting movement of the housing relative to the rail is limited by the drive wheel, which is arranged between the first and second holding devices, in an assembled configuration of the motorized drive device, and which is supported on the running surface of the rail, in an assembled configuration of the occultation or solar protection device.

As a result, when installing the motorized drive device on the rail, this motorized drive device construction may require adjustment of the pressure exerted by the elastic return element, so as to ensure that the drive wheel is supported on the running surface of the rail, whatever the opening or closing position of the screen relative to the rail, while avoiding a blocking of the motorized drive device, in particular of the electric motor, related to excessive force exerted on the running surface of the rail by the drive wheel.

Furthermore, a rotation axis of the drive wheel is fixed relative to the housing.

As a result, such an assembly of the drive wheel relative to the housing imposes a significant mounting effort of the motorized drive device relative to the rail, with this effort related to the pressure of the drive wheel against the running surface of the rail, when inserting the guide wheels of the first and second holding devices through a slot of the rail.

Document U.S. Pat. No. 3,620,284 A is also known, which describes a motorized drive device for an occultation or solar protection device. The motorized drive device comprises a housing, an electric motor, a drive wheel, a first holding device, a second holding device and two first elastic return elements. The drive wheel is configured to be rotated by the electric motor and to be supported on a running surface of a rail of the occultation or solar protection device, so as to move the motorized drive device along the rail in a direction of travel. The first holding device comprises a first guide wheel. The first guide wheel is configured to engage a first running track of the rail. The second holding device comprises a first guide wheel. The motorized drive device further comprises a drive unit. The drive unit is configured to be housed within the housing, in an assembled configuration of the motorized drive device. The drive unit comprises a casing, the electric motor and the drive wheel. The first elastic return elements are configured to interact, on one hand, with the housing and, on the other hand, with the casing. The drive wheel is configured to be supported on the running surface of the rail, by means of the first elastic return elements, in an assembled configuration of the occultation device. When the electric motor is electrically activated, the casing is configured to be tilted within the housing, relative to a median plane of the housing. This material is difficult to install on or remove from the rail when required.

### SUMMARY OF THE INVENTION

The object of the present invention is to solve the above-mentioned disadvantages and to provide a motorized drive device of an occultation or solar protection device, an occultation or solar protection device comprising such a motorized drive device, as well as a home automation installation comprising such an occultation or solar protection device, making it possible to facilitate mounting the motorized drive device relative to a rail, while ensuring a minimum pressure force of a drive wheel on a running surface of the rail, so as to avoid the drive wheel slipping on the running surface of the rail, when the electric motor is electrically activated, and an adaptation of this pressure force, depending on a weight of a screen of the occultation or solar protection device pulled by the motorized drive device, so as to optimize an efficiency of the motorized drive device, while facilitating the mounting and dismounting of the drive device relative to the rail.

To this end, according to a first aspect, the present invention provides for a motorized drive device of an occultation or solar protection device, the motorized drive device being provided for moving at least one screen along a rail in a sliding movement, the motorized drive device comprising at least:
a housing,
an electric motor,
a drive wheel, the drive wheel being configured to be rotated by means of the electric motor and to be supported on at least one running surface of the rail, so as to move the motorized drive device along the rail in a direction of movement,
a first holding device, the first holding device comprising at least a first guide wheel, the first guide wheel being configured to be supported with a first running track of the rail,
a second holding device, the second holding device comprising at least a first guide wheel, the first guide wheel being configured to be supported with the first running track of the rail,
a first elastic return element, and
a drive unit, the drive unit being configured to be housed within the housing, in an assembled configuration of the motorized drive device.

The drive unit comprises at least:
a casing,
the electric motor, and
the drive wheel.

The first elastic return element is configured to interact, on one hand, with the housing and, on the other hand, with the casing. The drive wheel is configured to be supported on the running surface of the rail, by the first elastic return element, in an assembled configuration of the occultation device. Furthermore, the casing is configured to be inclined within the housing, relative to a median plane of the housing, when the electric motor is electrically activated.

According to the invention, the motorized drive device further comprises at least: 1

a first switching mechanism, the first switching mechanism being configured to drive at least the first guide wheel of the first holding device between a first position and a second position, and vice versa.

The first position of the first guide wheel of the first holding device is a position in which the motorized drive device is configured to be mounted relative to the rail. The second position of the first guide wheel of the first holding device is a position in which the motorized drive device is configured to be dismounted relative to the rail. Furthermore, in the first position of the first switching mechanism and when the electric motor is electrically activated, the drive wheel is supported on the running surface of the rail, by means of the first elastic return element supported on a wall arranged in the housing, and is rotated, about the axis of rotation, by means of the electric motor.

Thus, this motorized drive device makes it possible to facilitate mounting the motorized drive device relative to a rail, while ensuring a minimum pressure force of a drive wheel on a running surface of the rail, so as to avoid the drive wheel slipping on the running surface of the rail, when the electric motor is electrically activated, and an adaptation of this pressure force, depending on a weight of a screen of the occultation or solar protection device pulled by the motorized drive device, so as to optimize the efficiency of the motorized drive device.

In this way, such a motorized drive device makes it possible to dispense with an additional pressurizing device of the drive wheel on the running surface of the rail arranged outside the housing.

Furthermore, the first switching mechanism facilitates the mounting and dismounting of the motorized drive device relative to the rail.

According to an advantageous feature of the invention, the casing comprises a first pin and a second pin. Furthermore, when the electric motor is electrically activated, the first pin or the second pin of the casing is supported against a shoulder of the housing, depending on the direction of rotation of the electric motor.

According to another advantageous feature of the invention, the first and second holding devices are connected to the housing by means of a chassis.

According to another advantageous feature of the invention, the motorized drive device further comprises at least: 1va second switching mechanism, the second switching mechanism being configured to drive at least the first guide wheel of the second holding device between a first position and a second position, and vice versa.

According to another advantageous feature of the invention, the first holding device further comprises a second guide wheel, the second guide wheel being configured to be made to be supported on a second running track of the rail. The second holding device further comprises a second guide wheel, the second guide wheel being configured to be made to be supported on the second running track of the rail.

According to a further advantageous feature of the invention, the second guide wheel of the respectively first or second holding device is fixed relative to the housing of the motorized drive device.

According to a second aspect, the present invention provides for an occultation or solar protection device comprising at least:
a screen,
a rail, and
a motorized drive device according to the invention and as mentioned above, with the screen being suspended from the rail and being movable along the rail, by means of the motorized drive device.

This occultation or solar protection device has similar features and advantages as described above, relative to the motorized drive device according to the invention.

According to one advantageous feature of the invention, the first guide wheels are configured to be inserted into or extracted from the rail, through a slot in the rail, so as to hold or detach the motorized drive device relative to the rail.

According to another advantageous feature of the invention, the second guide wheels are configured to be inserted into or extracted from the rail, through a slot in the rail, so as to hold or detach the motorized drive device relative to the rail.

According to another advantageous feature of the invention, in a first position of the respective first or second switching mechanism, the first guide wheel of the respective first or second holding device is offset relative to the second guide wheel of the respective first or second holding device, so as to hold the motorized drive device relative to the rail by pressing the first and second guide wheels respectively against the first and second running tracks of the rail. Furthermore, in a second position of the respective first or second switching mechanism, the first guide wheel of the respective first or second holding device is positioned opposite, in the direction of movement of the motorized drive device along the rail, the second guide wheel of the respective first or second holding device, so as to insert or extract the first and second guide wheels into or from the rail, through the slot of the rail.

According to a third aspect, the present invention provides for a home automation installation comprising an occultation or solar protection device according to the invention, as mentioned above.

This home automation installation has features and advantages similar to those described above, relative to the occultation or solar protection device according to the invention.

Further features and advantages of the invention will become apparent from the description below.

### BRIEF DESCRIPTION OF THE DRAWINGS

In the appended drawings, given as non-limiting examples:

FIG. 1 is a schematic perspective view of a part of a curtain comprising a motorized drive device according to one embodiment of the invention;

FIG. 2 is a schematic perspective view of the motorized drive device, illustrated in FIG. 1;

FIG. 3 is a first schematic side view of the motorized drive device, illustrated in FIGS. 1 and 2, showing a first guide wheel of a first holding device offset from a second guide wheel of the first holding device;

FIG. 4 is a second schematic side view of the motorized drive device, similar to FIG. 3, showing the second guide wheel of the first holding device positioned opposite the first guide wheel of the first holding device;

FIG. 5 is a schematic side view illustrating the assembly of the motorized drive device, illustrated in FIGS. 1 to 4, relative to a rail, where the first and second guide wheels of the first holding device are housed in the rail and brought, respectively, on a running track of the rail;

FIG. 6 is a schematic exploded perspective view of the motorized drive device, illustrated in FIGS. 1 to 5;

FIG. 7 is a schematic perspective view of the motorized drive device, illustrated in FIGS. 1 to 6, where a housing has been removed;

FIG. 8 is an exploded schematic perspective view of a part of the motorized drive device, illustrated in FIGS. 1 to 7, comprising a drive unit and an electronic control unit;

FIG. 9 is an exploded schematic perspective view of a part of the motorized drive device, illustrated in FIGS. 1 to 7, comprising a frame, a first holding device and a second holding device;

FIG. 10 is a schematic front view of the motorized drive device, illustrated in FIGS. 1 to 9, where the housing has been removed, this view showing a first and second switching device in a first position;

FIG. 11 is a schematic front view of the motorized drive device, illustrated in FIGS. 1 to 9, similar to FIG. 10, showing the first and second switching devices in a second position, different from the first position; and

FIG. 12 is a schematic cross-sectional view of the motorized drive device, illustrated in FIGS. 1 to 11, showing a positioning of the drive unit within the housing, when an electric motor of the drive unit is electrically activated, in a rotational direction.

### DESCRIPTION OF THE PREFERRED EMBODIMENTS

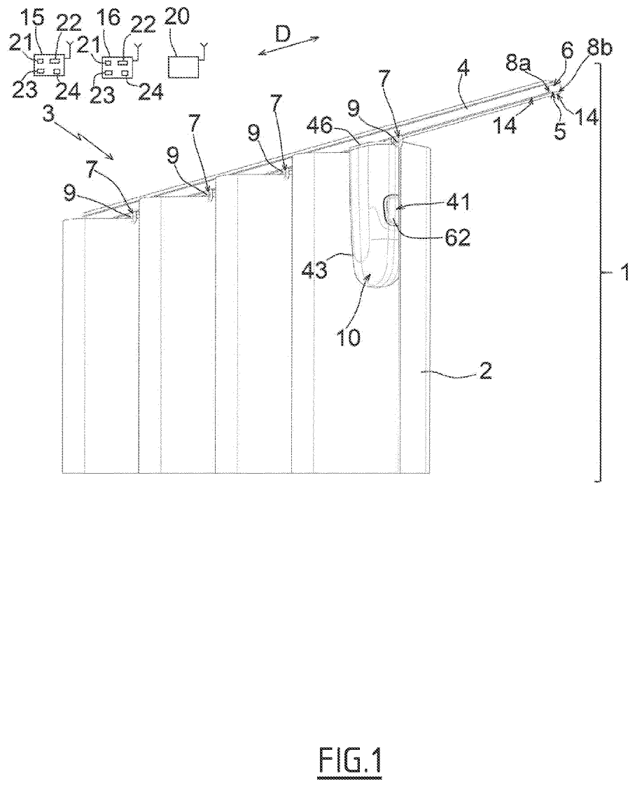

First, with reference to FIG. 1, a home automation installation 1 according to the invention is described, installed in a building comprising an opening, not shown, in which a window or a door is arranged, equipped with at least one screen 2 belonging to an occultation or solar protection device 3, in particular a motorized curtain.

The occultation or solar protection device 3 is hereinafter referred to as an “occultation device”. The occultation device 3 comprises the screen 2, which is formed by a curtain in the example of the Figures.

In a variant, the screen 2 can be formed by a blackout canvas, a curtain or even slats.

The occultation device 3 further comprises at least one rail 4. The rail 4 can also be called a rod or a bar. The rail 4 is a support element for mounting the screen 2 of the occultation device 3.

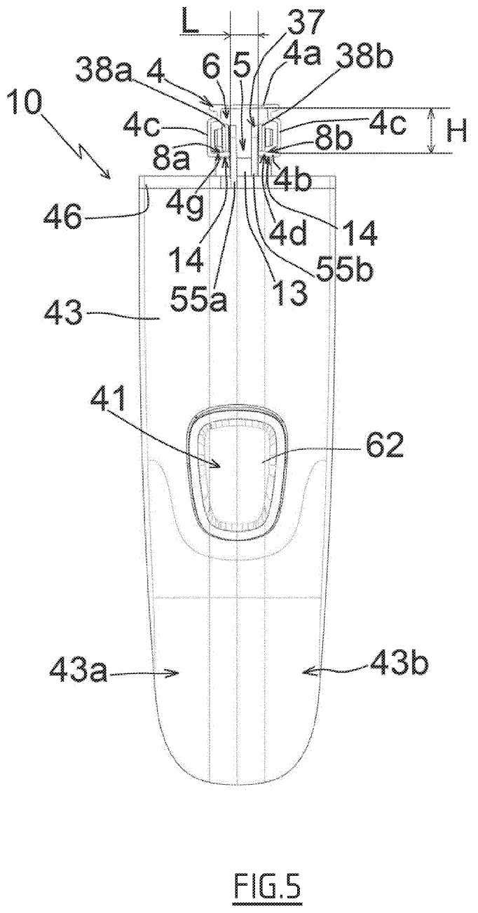

Here, the rail 4 comprises at least one slot 5, as illustrated in FIGS. 1 and 5.

Here and as illustrated in FIG. 5, the rail 4 comprises a top wall 4a, a bottom wall 4b and two side walls 4c. The bottom wall 4b of the rail 4 comprises the slot 5. The bottom wall 4b of the rail 4 comprises a first portion 4g and a second portion 4d, provided on either side of the slot 5.

Here, the rail 4 has a square cross section.

The rail section of the is not restrictive and may be different. It can be rectangular, for example.

Advantageously, the slot 5 of the rail 4 extends in a longitudinal direction of the rail 4.

Advantageously, the bottom wall 4b of the rail 4 comprises an inner face and an outer face.

Advantageously, the rail 4 further comprises a recess 6.

Here, the recess 6 of the rail 4 is formed between the top wall 4a, bottom wall 4b and side wall 4c of the rail 4.

Advantageously, the rail 4 is configured to be fixed, in other words is fixed, to a ceiling of a room in the building, in an assembled configuration of the installation 1.

Here, the occultation device 3 comprises a single screen 2 that can be moved along the rail 4. The screen 2 is suspended from the rail 4.

In a variant, not shown, the occultation device 3 comprises two screens 2. The two screens 2 can be moved along the same rail 4 or along two separate rails parallel to each other. In the case where two screens 2 can be moved along the same rail 4, they are each arranged near one end of the rail 4.

Advantageously, the occultation device 3 further comprises support elements 7 of the screen 2. The support elements 7 are configured to retain the screen 2 relative to the rail 4 and to move the screen 2 along the rail 4, in an assembled configuration of the occultation device 3.

The rail 4 further comprises at least a first running track 8a and at least a second running track 8b.

Advantageously, the first and second running tracks 8a, 8b of the rail 4 are provided on either side of the slot 5 of the rail 4.

Advantageously, the first and second running tracks 8a, 8b of the rail 4 are formed by the inner face of the bottom wall 4b of the rail 4 and, more particularly, by the inner face of the first and second portions 4g, 4d of the bottom wall 4b of the rail 4.

Advantageously, each support element 7 comprises a first and a second wheel, not shown. The first and second wheels of a support element 7 are configured to be supported with the respective first and second running tracks 8a, 8b of the rail 4, in the assembled configuration of the occultation device 3.

Advantageously, each support element 7 further comprises a hook 9. The hook 9 is configured to suspend the screen 2 relative to the rail 4, in the assembled configuration of the occultation device 3. Furthermore, the hook 9 is configured to extend through the slot 5 of the rail 4, in the assembled configuration of the occultation device 3.

The first and second wheels of each support element 7 are configured to be free to rotate, about an axis of rotation.

Advantageously, the axis of rotation of the first and second wheels of each support element 7 is orthogonal to a direction of movement D of the screen 2 along the rail 4.

The occultation device 3 further comprises at least one motorized drive device 10. The motorized drive device 10 is configured to be held on the rail 4, in other words suspended from the rail 4, in the assembled configuration of the occultation device 3, and to move along the rail 4, so as to close or open the screen 2. The motorized drive device 10 is provided, in other words is configured, to move the screen 2 along the rail 4 in a sliding movement.

Here, the rail 4 is a guide support of the motorized drive device 10.

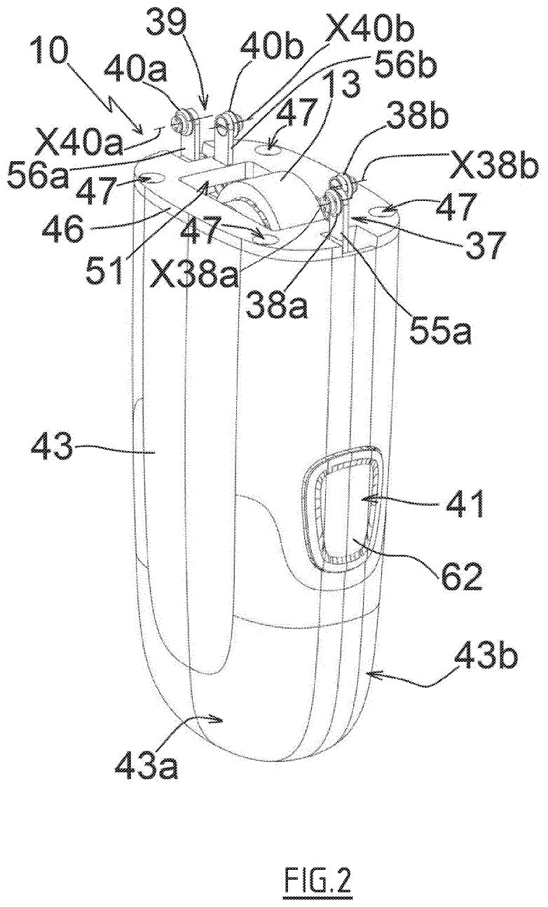

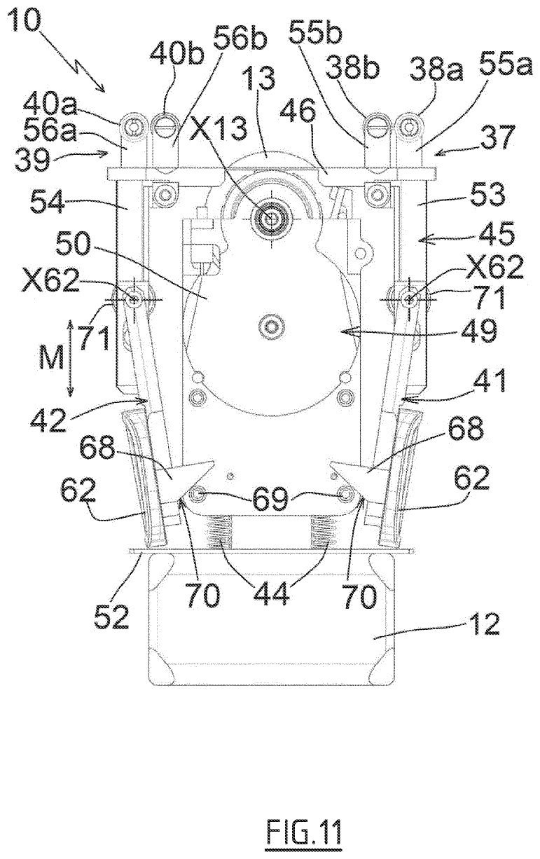

The motorized drive device 10 of the occultation device 3 illustrated in FIG. 1 is now described with reference to FIGS. 2 to 11.

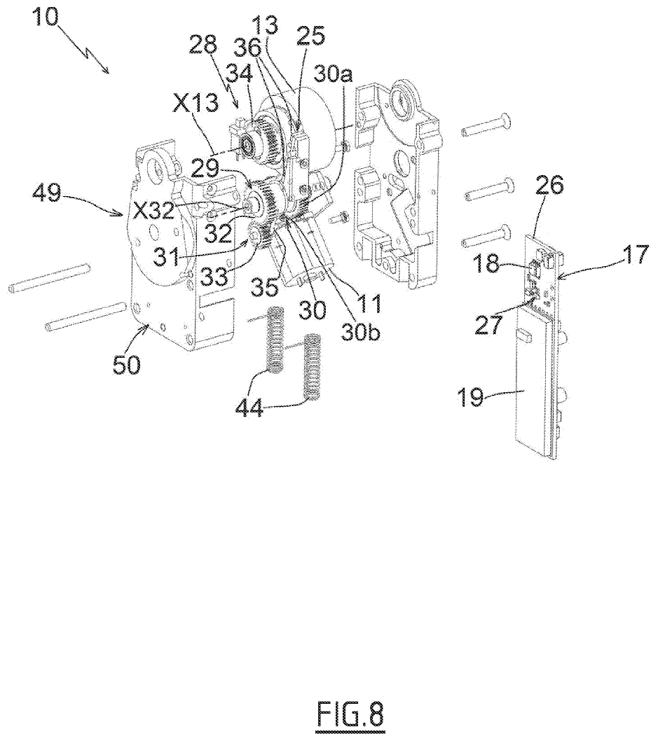

The motorized drive device 10 includes an electric motor 11, as illustrated in FIG. 8.

The electric motor 11 is supplied with electrical power by means of an electrical power source.

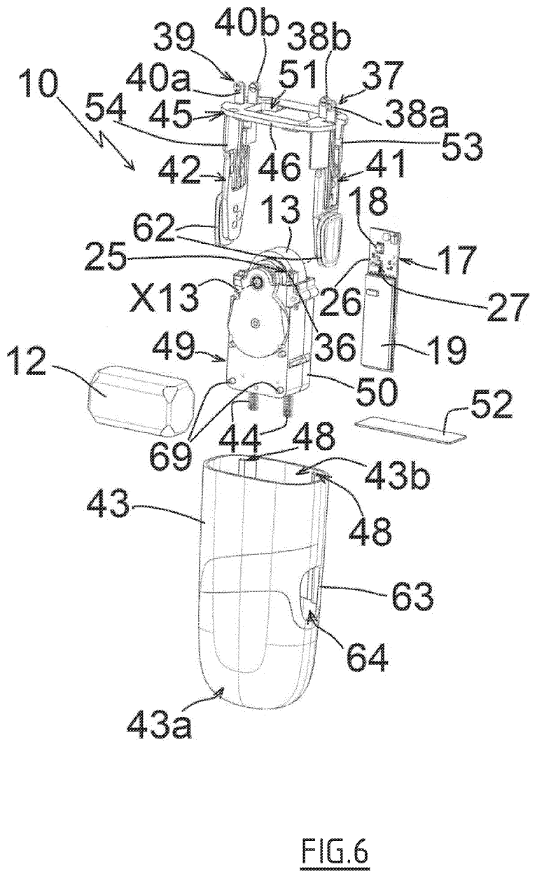

Advantageously, the electric power source may be a battery 12, for example, of the rechargeable type, in other words an accumulator, as illustrated in FIGS. 6 to 8, 10 and 11, or of the non-rechargeable type, in other words one or more battery cells.

Here, the electric motor 11 is of the brushless direct current type, also known as “BLDC”, or “permanent magnet synchronous”, or DC type.

Each support element 7 is configured to be moved along the rail 4, upon electrical activation of the electric motor 11 of the motorized drive device 10, so as to close or open the screen 2.

Advantageously, the motorized drive device 10 is configured to allow the screen 2 to be moved manually, in the event that the battery 12 has a state of charge below a threshold value.

The motorized drive device 10 further comprises a drive wheel 13.

The rail 4 further comprises at least one running surface 14, as illustrated in FIGS. 1 and 5.

The drive wheel 13 is configured to be rotated by means of the electric motor 11, in particular about an axis of rotation X13, and to be supported on the running surface 14 of the rail 4, so as to move the motorized drive device 10 along the rail 4.

Thus, the running surface 14 of the rail 4 is configured to interact, in other words interacts, with the drive wheel 13, in the assembled configuration of the occultation device 3.

Advantageously, the running surface 14 of the rail 4 is formed by the outer side of the bottom wall 4b of the rail 4 and, more particularly, by the outer side of the first and second parts 4g, 4d of the bottom wall 4b of the rail 4.

Here, the running surface 14 of the rail 4 is thus formed by two treads located on either side of the slot 5 of the rail 4.

In a variant, not shown, the running surface 14 of the rail 4 may be formed by a single tread located on either side of the slot 5 of the rail 4.

Here, the motorized drive device 10 is configured to move along the rail 4 in a direction of movement. The direction of movement of the motorized drive device 10 relative to the rail 4 corresponds to the longitudinal direction of the rail 4. Furthermore, the direction of movement of the motorized drive device 10 relative to the rail 4 is identical to the direction of movement D of the screen 2 along the rail 4.

Advantageously, the axis of rotation X13 of the drive wheel 13 is orthogonal to the direction of movement D of the motorized drive device 10 along the rail 4.

Advantageously, the motorized drive device 10 is controlled by a control unit 15, 16. The control unit may be, for example, a local control unit 15 or a central control unit 16, as illustrated in FIG. 1.

Advantageously, the local control unit 15 can be connected to the central control unit 16, in a wired manner or wirelessly.

Advantageously, the central control unit 16 can control the local control unit 15, as well as other similar local control units distributed throughout the building.

The motorized drive device 10 is, preferably, configured to execute commands for closing or opening the screen 2 of the occultation device 3, which can be transmitted, in particular, by the local control unit 15 or the central control unit 16.

The installation 1 comprises either the local control unit 15, the central control unit 16, or the local control unit 15 and the central control unit 16.

Means for controlling the motorized drive device 10, enabling movement of the screen 2 of the occultation device 3, comprise at least one electronic control unit 17, as illustrated in FIGS. 6 and 8. This electronic control unit 17 is capable of making the electric motor 11 operate and, in particular, of enabling the electric power supply to the electric motor 11. This electronic control unit 17 may also be capable of regulating a rotational speed of the electric motor 11, as well as modifying the rotational speed of the electric motor 11, in particular increasing this rotational speed when the electric motor 11 is started or decreasing this rotational speed when the electric motor 11 is stopped.

Thus, the electronic control unit 17 controls the electric motor 11, in particular, so as to close or open the screen 2.

The means for controlling of the motorized drive device 10 comprise hardware and/or software means. As a non-limiting example, the hardware means may comprise at least one microcontroller 18.

Advantageously, the electronic control unit 17 comprises a first communication module 19, as illustrated in FIG. 8, in particular for receiving command orders, the command orders being issued by a command emitter, such as the local control unit 15 or the central control unit 16, these command orders being intended to control the motorized drive device 10.

Preferably, the first communication module 19 of the electronic control unit 17 is of a wireless type. In particular, the first communication module 19 is configured to receive radio command orders.

Advantageously, the electronic control unit 17, the local control unit 15 and/or the central control unit 16 can communicate with one or more sensors, not shown, arranged inside the building or left outside the building. This or these sensors can be configured to determine temperature, luminosity or humidity, for example.

Advantageously, the electronic control unit 17, the local control unit 15 and/or the central control unit 16 can also communicate with a server 20, as illustrated in FIG. 1, so as to control the motorized drive device 10 based on to data made available remotely by means of a communication network, in particular an internet network that can be connected to the server 20.

The electronic control unit 17 can be controlled from the local control unit 15 or central control unit 16. The local control unit 15 or central control unit 16 is provided with a control keyboard. The control keyboard of the local control unit 15 or central control unit 16 comprises one or more selection elements 21 and, eventually, one or more display elements 22.

By way of non-limiting examples, the selection elements may include push buttons and/or touch sensitive keys. The display elements may include light-emitting diodes and/or a LCD display (Liquid Crystal Display) or TFT display (Thin Film Transistor). The selection and display elements can also be made by means of a touch screen.

The local control unit 15 or central control unit 16 comprises at least one second communication module 23.

Thus, the second communication module 23 of the local control unit 15 or central control unit 16 is configured to transmit, in other words transmit, command orders, in particular by wireless means, for example radio, or by wired means.

Furthermore, the second communication module 23 of the local control unit 15 or central control unit 16 may also be configured to receive, in other words receive, command orders, in particular by means of the same means.

The second communication module 23 of the local control unit 15 or central control unit 16 is configured to communicate, in other words communicate, with the first communication module 19 of the electronic control unit 17.

Thus, the second communication module 23 of the local control unit 15 or central control unit 16 exchanges command orders with the first communication module 19 of the electronic control unit 17, either mono-directionally or bi-directionally.

Advantageously, the local control unit 15 is a control point, which may be fixed or nomadic. A fixed control point can be a control box intended to be fixed on a façade of a building wall or on a face of a window or door frame. A nomadic control point may be a remote control, a smartphone or a tablet.

Advantageously, the local control unit 15 or central control unit 16 also includes a controller 24.

The motorized drive device 10, in particular the electronic control unit 17, is, preferably, configured to execute movement command orders, in particular for closing as well as opening, of the screen 2 of the occultation device 3. These command orders can be transmitted, in particular, by the local control unit 15 or the central control unit 16.

The motorized drive device 10 can be controlled by the user, for example by receiving a command order corresponding to pressing the or one of the selection elements 21 of the local control unit 15 or central control unit 16.

The motorized drive device 10 may also be controlled automatically, for example by receiving a command order corresponding to at least one signal from at least one sensor and/or a signal from a clock of the electronic control unit 17, in particular the microcontroller 18. The sensor and/or the clock may be integrated in the local control unit 15 or in the central control unit 16.

Advantageously, the motorized drive device and, more particularly, the electronic control unit 17 is configured to electrically activate the electric motor 11, following a detection of a movement of the screen 2 implemented manually, in particular by the user.

Thus, the movement of the screen 2 is implemented manually, in a first step, and, in a second step, automatically by means of the motorized drive device 10.

In this way, the movement of the screen 2 is started manually and then continued automatically by the motorized drive device 10.

Here, the detection of a manual movement of the screen 2 is implemented by the electronic control unit 17 and, in particular, by means of a counting device 25, as illustrated in FIGS. 5 and 8.

Advantageously, the electronic control unit 17 is configured to determine a direction of movement of the screen 2 implemented manually, so as to control the electric motor 11 based on the direction of movement determined.

Here, detection of the manual movement direction of the screen 2 is implemented by the electronic control unit 17 and, in particular, by means of the counting device 25.

Here, the electronic control unit 17 comprises a first electronic board 26, configured to drive the electric motor 11, and a second electronic board, not shown, equipped with the first communication module 19, configured to receive command orders and, eventually, to transmit messages.

In a variant, not shown, the electronic control unit 17 comprises a single electronic board 26, equipped with the first communication module 19, configured to drive the electric motor 11 and to receive command orders and, eventually, to transmit messages.

Advantageously, the electronic control unit 17 comprises a measuring device 27 of an intensity value I of an electric current flowing through the electric motor 11.

Thus, the measuring device 27 can learn end-of-travel positions, closed or open, of the screen 2 and detect one of these end-of-travel positions being reached, during electric activation of the electric motor 11.

Advantageously, the motorized drive device 10 further comprises a transmission device 28, as illustrated in FIG. 8. The transmission device 28 is configured to be connected, in other words is connected, to the electric motor 11, in an assembled configuration of the motorized drive device 10. Furthermore, the transmission device 28 is configured to drive the drive wheel 13, during electrical activation of the electric motor 11.

Advantageously, the transmission device 28 comprises a gearbox 29.

Here, the gearbox 29 comprises two reduction stages. A first reduction stage of the gearbox 29 is formed by a wheel and worm system 30. A second reduction stage of the gearbox 29 is formed by a gear system 31 comprising an input gear 32, a satellite gear 33 and an output gear 34. A wheel 30a of the wheel and worm system 30 is meshed with a screw 30b of the gear and worm system 30. The satellite gear 33 is mounted on a pivoting arm 35. The wheel 30a of the wheel and worm system 30 is integral with the input gear 32 and, more particularly, the wheel 30a and the input gear 32 have a common axis of rotation X32. The pivoting arm 35 is connected to the input gear 32. The satellite gear 33 is configured to be meshed with the output gear 34, depending on an angular orientation of the pivoting arm 35 relative to the input gear 32. Furthermore, the output gear 34 is integral with the drive wheel 13.

The type and number of reduction stages of the gearbox are not limiting and may be different.

Advantageously, when a command to stop the electric motor 11 is executed by the electronic control unit 17, a drive of the electric motor 11 in a direction of rotation opposite to the initial direction of rotation of the electric motor 11 is implemented, so as to disengage the gearbox 29, in particular the second reduction stage.

Here, disengagement of the gearbox 29 is implemented by a backward movement of the pivoting arm 35, so as to disengage the satellite gear 33 relative to the output gear 34.

Thus, following disengagement of the gearbox 29, in particular of the second reduction stage of the gearbox 29, the motorized drive device 10 and, more particularly, the screen 2 can be moved manually relative to the rail 4.

Advantageously, the motorized drive device 10 comprises the counting device 25. Furthermore, the counting device 25 is configured to interact with the electronic control unit 17.

Advantageously, the counting device 25 comprises at least one sensor 36, in particular a position sensor.

Here and as illustrated in FIGS. 6 and 8, the counting device 25 comprises two sensors 36, only one of which is visible in FIG. 6.

The number of sensors in the counting device is not limiting and may be different, in particular equal to one or greater than or equal to three.

In one example embodiment, the counting device 25 is of the magnetic type, such as an encoder equipped with one or more Hall effect sensors.

Here, the counting device 25 is used to determine the angular position of the drive wheel 13.

In a variant, the counting device 25 is used to determine the number of revolutions made, by a rotor of the electric motor 11, from a reference position.

The type of counting device 25 is not limiting and may be different. In particular, this counting device may be of the optical type, for example an encoder equipped with one or more optical sensors, or of the temporal type, for example a clock of the microcontroller.

Thus, the counting device 25 may enable detection of one of the end-of-travel positions being reached.

In a variant, the motorized drive device 10 may comprise a first counting device 25 provided with one or more sensors 36 and a second time-based counting device, not shown, implemented, for example, by means of a clock of the microcontroller 18.

Thus, the first counting device 25 may enable detection of reaching one of the end-of-travel positions and the second counting device may enable determination of intermediate positions between the two end-of-travel positions, so as to minimize an electric power consumption of the motorized driving device 10 and to increase an operating time of the battery 12.

Advantageously, the electronic control unit 17, in particular the microcontroller 18, is configured to determine the disengagement of the gearbox 29, in particular of the second reduction stage of the gearbox 29, by means of the counting device 25, in particular by means of one or more signals transmitted by the counting device 25 to the electronic control unit 17.

The disengagement of the gearbox 29, in particular of the second reduction stage of the gearbox 29, following a command to stop the electric motor 11, can thus make it possible to start the electric motor 11 automatically, following detection of movement of the screen 2 implemented manually, in particular by means of the counting device 25, so as to move the screen 2 relative to the rail 4.

The disengagement of the gearbox 29, in particular of the second reduction stage, following to a command to stop the electric motor 11, can also make it possible for the screen 2 to be closed or opened manually, in the event that the battery 12 is discharged, in other words has a state of charge below a predetermined threshold value.

The motorized drive device 10 further comprises a first holding device 37 and a second holding device 39. The first holding device 37 comprises at least a first guide wheel 38a and, eventually, a second guide wheel 38b. The first and second guide wheels 38a, 38b are configured to be supported on the respective first and second running tracks 8a, 8b of the rail 4, so as to hold or release the motorized drive device 10 relative to the rail 4. The second holding device 39 comprises at least a first and a second guide wheel 40a, 40b. The first and second guide wheels 40a, 40b are configured to be supported on the at least respective first and second running tracks 8a, 8b of the rail 4, so as to hold or detach the motorized drive device 10 relative to the rail 4.

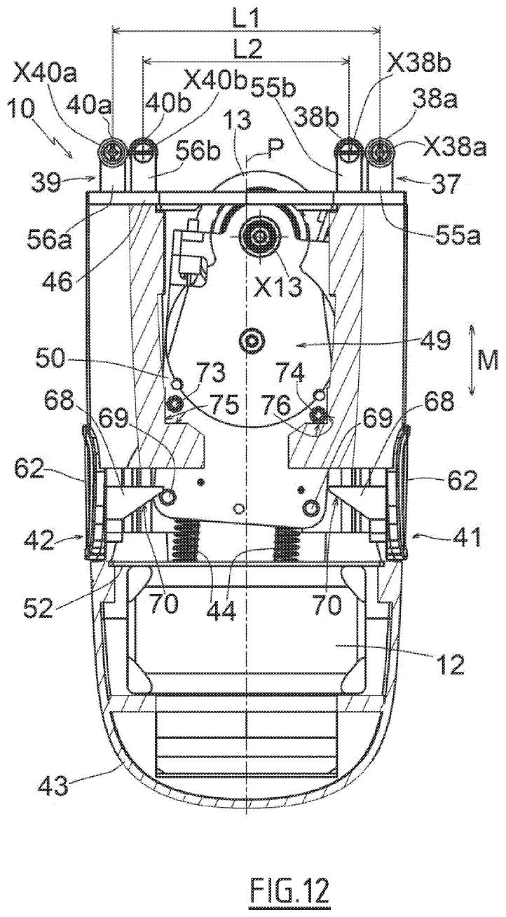

Advantageously, a center distance L1 between the first guide wheel 38a of the first holding device 37 and the first guide wheel 40a of the second holding device 39 is fixed, whether in an electrically deactivated or electrically activated state of the electric motor 11. This center distance L1 is illustrated in FIG. 12.

Advantageously, a center distance L2 between the second guide wheel 38b of the first holding device 37 and the second guide wheel 40b of the second holding device 39 is fixed, whether in an electrically deactivated or electrically activated state of the electric motor 11. This center distance L2 is illustrated in FIG. 12.

Advantageously, the center distance L1, L2 is kept fixed between the respective first guide wheel 38a or second guide wheel 38b of the first holding device 37 and the respective first guide wheel 40a or second guide wheel 40 of the second holding device 39, following to the motorized drive device 10 being held relative to the rail 4, by means of the first and second holding devices 37, 39, in the assembled configuration of the occultation device 3.

Here, the first and second guide wheels 38a, 38b, 40a, 40b of the first and second holding devices 37, 39 are configured to be inserted into or extracted from the rail 4, through the slot 5 of the rail 4.

Thus, in the example embodiment illustrated in FIGS. 2 to 11, the motorized drive device 10 comprises the first holding device 37 and the second holding device 39. The first holding device 37 comprises at least a first pair of guide wheels 38a, 38b and the second holding device 39 comprises at least a second pair of guide wheels 40a, 40b. Furthermore, each of the first and second running tracks 8a, 8b of the rail 4 is configured to interact, in other words interacts, with one of the guide wheels 38a, 38b, 40a, 40b of each of the first and second holding devices 37, 39, in the assembled configuration of the occultation device 3.

In this way, the first pair of guide wheels 38a, 38b is configured to be inserted into the rail 4, through the slot 5 of the rail 4, and to be supported on the first and second running tracks 8a, 8b of the rail 4, so as to hold the motorized drive device 10 relative to the rail 4. Furthermore, the second pair of guide wheels 40a, 40b is configured to be inserted into the rail 4, through the slot 5 of the rail 4, and to be supported on the first and second running tracks 8a, 8b of the rail 4, so as to hold the motorized drive device 10 relative to the rail 4.

In a variant, not shown, the first holding device 37 may comprise two or more pairs of guide wheels 38a, 38b. In the same way, the second holding device 39 may comprise two or more pairs of guide wheels 40a, 40b.

The first and second guide wheels 38a, 38b, 40a, 40b of the respective first holding device 37 or second holding device 39 are configured to be free to rotate, in particular about an axis of rotation X38a, X38b, X40a, X40b, as illustrated in FIGS. 2 and 12. The center distance L1 is defined between the axes X38a and X40a. The center distance L2 is defined between the axes X38b and X40b.

Advantageously, the first and second guide wheels 38a, 38b, 40a, 40b of the respective first holding device 37 or second holding device 39 are configured to be housed, in other words are housed, inside the recess 6 of the rail 4, in the assembled configuration of the occultation device 3.

Advantageously, the first and second holding devices 37, 39 are configured to be arranged, in other words are arranged, on either side of the axis of rotation X13 of the drive wheel 13, along the direction of movement D of the motorized drive device 10 along the rail 4, in the assembled configuration of the motorized drive device 10.

Advantageously, the axis of rotation X38a, X38b, X40a, X40b of the first and second guide wheels 38a, 38b, 40a, 40b of the respective first holding device 37 or second holding device 39 is orthogonal to the direction of movement D of the motorized drive device 10 along the rail 4.

The motorized drive device 10 further comprises at least one switching mechanism 41, 42.

Here, the motorized drive device 10 comprises a first switching mechanism 41 and a second switching mechanism 42.

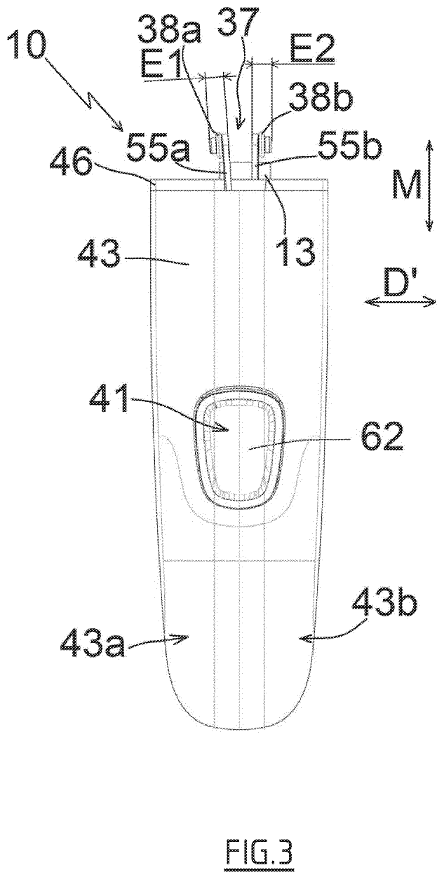

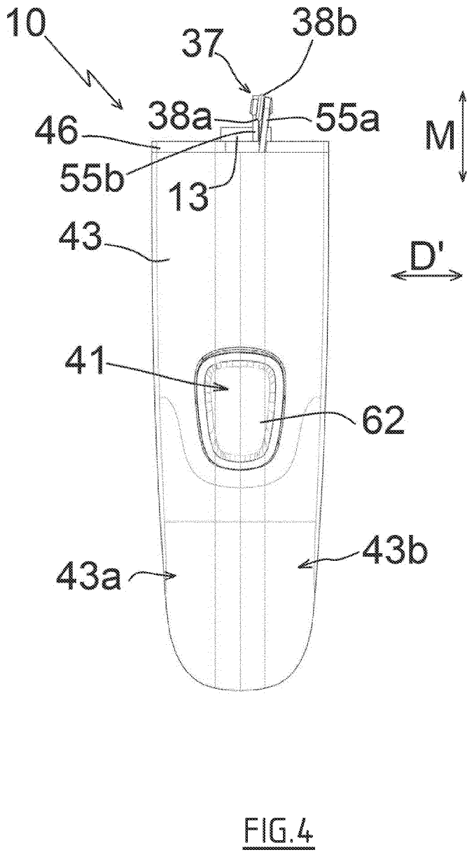

The first switching mechanism 41 is configured to drive the first guide wheel 38a of the first holding device 37 between a first position, as illustrated in FIG. 3, and a second position, as illustrated in FIG. 4, and vice versa, in particular relative to the second guide wheel 38b of the first holding device 37.

Moreover, the second switching mechanism 42 is configured to drive the first guide wheel 40a of the second holding device 39 between a first position and a second position, and vice versa, in particular relative to the second guide wheel 40b of the second holding device 39.

The first position of the first guide wheel 38a, 40a of the respective first holding device 37 or second holding device 39 is a position in which the motorized drive device 10 is configured to be mounted relative to the rail 4. Here, the first and second guide wheels 38a, 38b, 40a, 40b are configured to be supported, respectively, on at least one of the first and second running tracks 8a, 8b of the rail 4.

The second position of the first guide wheel 38a, 40a of the respective first holding device 37 or the second holding device 39 is a position in which the motorized drive device 10 is configured to be dismounted relative to the rail 4. Here, the first and second guide wheels 38a, 38b, 40a, 40b are configured to be inserted into or extracted from the rail 4, through the slot 5 of the rail 4.

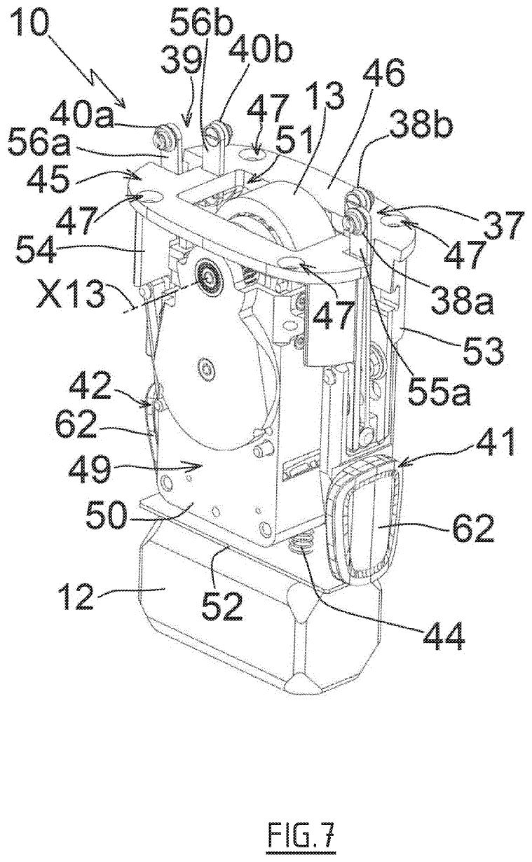

The motorized drive device 10 further comprises at least one housing 43, which is not shown in FIGS. 7 to 11.

Advantageously, the housing 43 comprises a first half-shell 43a and a second half-shell 43b. Furthermore, the first and second half-shells 43a, 43b are configured to be assembled, in other words are assembled, together, by means of fastening elements, not shown, in the assembled configuration of the motorized drive device 10.

Here, the fastening elements of the housing 43 are elastic snap-in fastening elements.

The type of the fastening elements is not limiting and may be different. It may be, for example, screw-fastening elements.

Advantageously, one of the first and second half-shells 43a, 43b is a hatch, so as to allow access to the battery 12, in particular to replace the latter.

The motorized drive device 10 further comprises at least one first elastic return element 44. The or each first elastic return element 44 is configured to press the drive wheel 13 against the running surface 14 of the rail 4, in the assembled configuration of the occultation device 3 and, more particularly, in the first position of the first and second switching mechanisms 41, 42.

Here, the motorized drive device 10 comprises two first elastic return elements 44. Furthermore, each first elastic return element 44 is a spring, in particular a compression spring, and is formed as a spiral.

The number and shape of the first elastic return elements are not limiting and may be different. The number of first elastic return elements may be one, three or more. Furthermore, the or each first elastic return element may be a tension spring and may be made as a pin or may be a leaf spring.

Advantageously, the drive wheel 13 is movable, in particular in a translational movement M, as illustrated in FIGS. 3, 4 and 10 to 12, inside the housing 43, so as to be supported on the running surface 14 of the rail 4, by means of the first elastic return elements 44, in the assembled configuration of the occultation device 3 and, more particularly, in the first position of the first and second switching mechanisms 41, 42.

Advantageously, the motorized drive device 10 comprises a chassis 45. Furthermore, the first and second holding devices 37, 39 are connected to the housing 43 by means of the chassis 45.

Thus, the chassis 45 is configured to interact, in other words interacts, with the respective first holding device 37 or second holding device 39, in the assembled configuration of the motorized drive device 10.

Advantageously, the chassis 45 comprises a wall 46, in particular a top wall.

Here, the wall 46 of the chassis 45 is a closure wall of the housing 43.

Advantageously, in the assembled configuration of the occultation device 3, the wall 46 of the chassis 45 is parallel to the running surface 14 of the rail 4.

Advantageously, the chassis 45 is configured to interact, in other words interacts, with the respective first switching mechanism 41 or second switching mechanism 42, in the assembled configuration of the motorized drive device 10.

Advantageously, the chassis 45 is integral with the housing 43.

Here, in the assembled configuration of the motorized drive device 10, the chassis 45, in particular the wall 46 of the chassis 45, is fixed to the housing 43, by means of fixing elements, not shown.

Here, the fixing elements of the chassis 45 relative to the housing 43 are fastening screws, four in number, and are not shown. Each fastening screw is placed through a through-hole 47 in the wall 46 of the chassis 45 and is screwed into a fastening hole 48 in the housing 43, in the assembled configuration of the motorized drive device 10. Only two of the fastening holes 48 in the housing 43 are shown in FIG. 6.

The number and type of fixing elements are not limiting and may be different. The number of fixing elements may be, for example, two, three, five or more. Furthermore, the type of fixing elements may be, for example, by snap-in elastic.

The motorized drive device 10 further comprises a drive unit 49. The drive unit 49 is configured to be housed, in other words is housed, within the housing 43, in the assembled configuration of the motorized drive device 10. The drive unit 49 comprises a casing 50.

The drive unit 49 further comprises at least the electric motor 11, the drive wheel 13 and, eventually, the transmission device 28.

Advantageously, the electric motor 11 and, eventually, the transmission device 28 are configured to be housed, in other words are housed, within the casing 50 of the drive unit 49 and, as a result, within the housing 43, in the assembled configuration of the motorized drive device 10.

Advantageously, the drive wheel 13 is configured to be housed, in other words is housed, partially within the casing 50 of the drive unit 49 and is configured to be placed, in other words is placed, partially outside of the casing 50 of the drive unit 49, in the assembled configuration of the motorized drive device 10.

Here, the drive wheel 13 is configured to be housed, in other words is housed, at least partially within the housing 43, or even completely, in the second position of the first and second switching mechanisms 41, 42. Furthermore, the drive wheel 13 is configured to be placed, in other words is placed, partially outside the housing 43, in the first position of the first and second switching mechanisms 41, 42.

Advantageously, the drive wheel 13 is configured to be placed, in other words is placed, in the central part of the wall 46 of the chassis 45 and, more particularly, through a central opening 51 of the wall 46 of the chassis 45, in the assembled configuration of the motorized drive device 10.

The or each first elastic return element 44 is configured to interact, on one hand, with the housing 43 of the motorized drive device 10 and, on the other hand, with the casing 50 of the drive unit 49.

Thus, the drive unit 49 is movable, in particular along the translational movement M, within the housing 43, by means of the first elastic return elements 44, so as to support the drive wheel 13 on the running surface 14 of the rail 4, in the assembled configuration of the occultation device 3 and, more particularly, in the first position of the first and second switching mechanisms 41, 42.

Here, the first elastic return elements 44 are configured to interact, on one hand, with a support wall 52 arranged in the lower part of the housing 43 of the motorized drive device 10 and, on the other hand, with the casing 50 of the drive unit 49.

Advantageously, in the assembled configuration of the occultation device 3, the support wall 52 is parallel to the running surface 14 of the rail 4.

In this embodiment, the support wall 52 is removable and is supported against the housing 43, in particular at an area of a bottom region of the housing 43.

In the assembled configuration of the occultation device 3 and, more particularly, in the first position of the first and second switching mechanisms 41, 42, the first elastic return elements 44 make it possible to take into consideration a change in a mass of the screen 2 to be pulled or pushed by means of the motorized drive device 10, during movement of the motorized drive device 10 along the rail 4 by the electric activation of the electric motor 11, both for closing the screen 2 and for opening the screen 2, by adjusting a pressure exerted by the drive wheel 13 on the running surface 14 of the rail 4.

Advantageously, the first and second guide wheels 38a, 38b, 40a, 40b of the respective first holding device 37 or second holding device 39 are configured to be arranged, in other words are arranged, outside the housing 43, in the assembled configuration of the motorized drive device 10.

Advantageously, the first and second holding devices 37, 39 are identical.

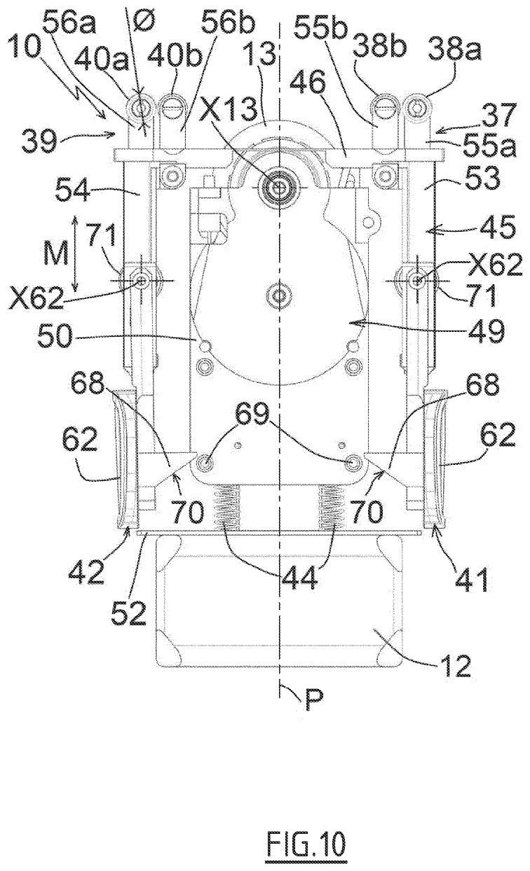

Advantageously, the first and second holding devices 37, 39 are configured to be arranged, in other words are arranged, symmetrically relative to a median plane P of the motorized drive device 10 and, more particularly, of the housing 43, with the track of this median plane P illustrated in FIGS. 10 and 12.

Here, as visible in FIG. 2, in the first position of the respective first switching mechanism 41 or second switching mechanism 42, the first and second guide wheels 38a, 38b, 40a, 40b of the respective first holding device 37 or second holding device 39 are arranged in a staggered arrangement.

Advantageously, in a first position of the respective first switching mechanism 41 or second switching mechanism 42, the first guide wheel 38a, 40a of the respective first holding device 37 or second holding device 39 is offset relative to the second guide wheel 38b, 40b of the respective first holding device 37 or second holding device 39, so as to hold the motorized drive device 10 relative to the rail 4 by bringing the first and second guide wheels 38a, 38b, 40a, 40b respectively into contact with the first and second running tracks 8a, 8b of the rail 4. Furthermore, in a second position of the respective first switching mechanism 41 or second switching mechanism 42, the first guide wheel 38a, 40a of the respective first holding device 37 or second holding device 39 is positioned opposite, in the direction of movement D of the motorized drive device 10 along the rail 4, of the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

Thus, the offset of the first guide wheel 38a, 40a of the respective first holding device 37 or second holding device 39, relative to the second guide wheel 38b, 40b of the respective first holding device 37 or second holding device 39, ensures that the motorized drive device 10 is held relative to the rail 4 and, more particularly, that the first and second guide wheels 38a, 38b, 40a, 40b are supported on the respective first and second tracks 8a, 8b of the rail 4. Furthermore, the alignment of the first guide wheel 38a, 40a of the respective first holding device 37 or second holding device 39, relative to the second guide wheel 38b, 40b of the respective first holding device 37 or second holding device 39, allows the first and second guide wheels 38a, 38b, 40a, 40b to be inserted into or extracted from the rail 4, through the slot 5 of the rail 4.

In this way, the offset of the first and second guide wheels 38a, 38b, 40a, 40b of the respective first holding device 37 or second holding device 39, in the first position of the first and second switching mechanisms 41, 42, ensures the movement of the motorized drive device 10 along the rail 4, by means of the drive wheel 13 and the electric motor 11. Furthermore, the alignment of the first and second guide wheels 38a, 38b, 40a, 40b of the respective first holding device 37 or second holding device 39, in the second position of the first and second switching mechanisms 41, 42, allows for easy insertion or extraction of the first and second guide wheels 38a, 38b, 40a, 40b relative to the rail 4, without having to disassemble the screen 2 or the rail 4.

Here, in the first position of the respective first switching mechanism 41 or second switching mechanism 42, the first guide wheel 38a, 40a of the respective first holding device 37 or second holding device 39 is offset relative to the second guide wheel 38b, 40b of the respective first holding device 37 or second holding device 39, in a transverse direction D′, visible in FIGS. 3 and 4, orthogonal to the direction of movement D of the motorized drive device 10 along the rail 4 and orthogonal to the translational movement M of the drive wheel 13 relative to the housing 43. Furthermore, in the second position of the respective first switching mechanism 41 or second switching mechanism 42, the second guide wheel 38b, 40b of the respective first holding device 37 or second holding device 39 is positioned opposite, in the transverse direction D′, at the same level as the first guide wheel 38a, 40a of the respective first holding device 37 or second holding device 39, so that the first and second guide wheels 38a, 38b, 40a, 40b can be inserted into or extracted from the rail 4, through the slot 5 of the rail 4. In other words, in the second position of the respective first switching mechanism 41 or second switching mechanism 42, the second guide wheel 38b, 40b of the respective first holding device 37 or second holding device 39 is aligned with the first guide wheel 38a, 40a of the respective first holding device 37 or second holding device 39, in the direction D of movement of the motorized drive device 10 along the rail 4.

Such a motorized drive device 10 can thus easily be mounted or dismounted relative to the rail 4, without tools and, in particular, by a user.

Furthermore, such a motorized drive device 10 comprising the first holding device 37 and the second holding device 39 can be held, in other words suspended, to the rail 4 without having to make an adjustment of an element of this motorized drive device 10.

Advantageously, the first guide wheel 38a, 40a of the respective first holding device 37 or second holding device 39 is movable relative to the second guide wheel 38b, 40b of the respective first holding device 37 or second holding device 39. Furthermore, movement of the first guide wheel 38a, 40a of the respective first holding device 37 or second holding device 39, relative to the second guide wheel 38b, 40b of the respective first holding device 37 or second holding device 39, is implemented by the first and second switching mechanisms 41, 42.

Here, the movement of the first guide wheel 38a, 40a of the respective first holding device 37 or second holding device 39, relative to the second guide wheel 38b, 40b of the respective first holding device 37 or second holding device 39, implemented by means of the respective first switching mechanism 41 or second switching mechanism 42, is a rotational movement, preferably about an axis parallel to the transverse direction D′.

In a variant, not shown, the movement of the first guide wheel 38a, 40a of the respective first holding device 37 or second holding device 39, relative to the second guide wheel 38b, 40b of the respective first holding device 37 or second holding device 39, implemented by means of the respective first switching mechanism 41 or second switching mechanism 42, is a translational movement.

Advantageously, the second guide wheel 38b, 40b of the respective first holding device 37 or second holding device 39 is fixed relative to the housing 43 and, more particularly, relative to the wall 46 of the chassis 45.

Advantageously, the chassis 45 further comprises a first branch 53 and a second branch 54.

Here, the first and second legs 53, 54 extend inside the housing 43 from the wall 46 of the chassis 45 and, in particular, in a direction orthogonal to the wall 46 of the chassis 45.

Advantageously, the drive unit 49 is configured to be mounted, in other words is mounted, between the first and second legs 53, 54 of the chassis 45, in the assembled configuration of the motorized drive device 10.

Advantageously, the respective first holding device 37 or second holding device 39 further comprises at least a first arm 55a, 56a and a second arm 55b, 56b, The first arm 55a, 56a is connected, on one hand, to the first guide wheel 38a, 40a of the respective first holding device 37 or second holding device 39, and, on the other hand, to the respective first switching mechanism 41 or second switching mechanism 42. Furthermore, the second arm 55b, 56b is connected, on one hand, to the second guide wheel 38b, 40b of the respective first holding device 37 or second holding device 39, and, on the other hand, to the housing 43 and, more particularly, to the chassis 45, in this case to the wall 46 of the chassis 45.

Thus, the movement of the first guide wheel 38a, 40a of the respective first holding device 37 or second holding device 39, relative to the second guide wheel 38b, 40b of the respective first holding device 37 or second holding device 39, is implemented by a movement of the respective first arm 55a of the first holding device 37 or the first arm 56a of the second holding device 39, relative to the respective second arm 55b of the first holding device 37 or second holding device 39.

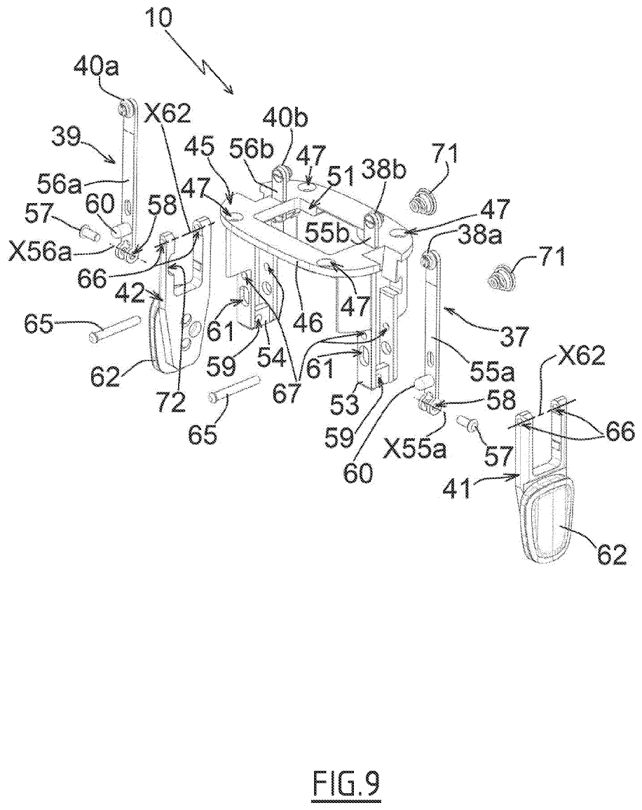

Advantageously, the first arm 55a, 56a of the respective first holding device 37 or second holding device 39 is rotatably mounted, about an axis of rotation X55a, X56a, relative to the chassis 45 and, more particularly, relative to the respective first branch 53 or second branch 54 of the chassis 45, as illustrated in FIG. 9.

Here and as illustrated in FIG. 9, the rotational movement of the first arm 55a, 56a of the respective first holding device 37 or second holding device 39, relative to the chassis 45 is implemented by means of a rotation shaft 57 inserted, on one hand, in at least one opening 58 of the first arm 55a, 56a of the respective first holding device 37 or second holding device 39, and, on the other hand, in at least one opening 59 of the chassis 45 and, more particularly, of the respective first arm 53 or second arm 54 of the chassis 45.

Advantageously, the rotational movement of the first arm 55a, 56a of the respective first holding device 37 or second holding device 39, relative to the chassis 45, has limited travel.

Here and as illustrated in FIG. 9, the travel of the rotational movement of the first arm 55a, 56a of the respective first holding device 37 or second holding device 39, relative to the chassis 45, is determined by a stop 60 of the first arm 55a, 56a of the respective first holding device 37 or second holding device 39.

Advantageously, the stop 60 of the first arm 55a, 56a of the respective first holding device 37 or second holding device 39 is configured to interact, in other words interacts, with an opening 61 of the chassis 45 and, more particularly, of the respective first branch 53 or second branch 54 of the chassis 45, in particular of oblong shape.

Advantageously, the first arm 55a, 56a and the first guide wheel 38a, 40a of the respective first holding device 37 or second holding device 39 have a first cumulative thickness E1, in the assembled configuration of the motorized drive device 10, as illustrated in FIG. 3. The second arm 55b, 56b and the second guide wheel 38b, 40b of the respective first holding device 37 or second holding device 39 have a second cumulative thickness E2, in the assembled configuration of the motorized drive device 10, as illustrated in FIG. 3. Furthermore, the first cumulative thickness E1 of the first arm 55a, 56a and the first guide wheel 38a, 40a and the second cumulative thickness E2 of the second arm 55b, 56b and the second guide wheel 38b, 40b, are respectively smaller than a width L of the slot 5 of the rail 4, as shown in FIG. 5.

Here, the first cumulative thickness E1 of the first arm 55a, 56a and the first guide wheel 38a, 40a is equal to the second cumulative thickness E2 of the second arm 55b, 56b and the second guide wheel 38b, 40b.

Advantageously, the first and second guide wheels 38a, 38b of the first holding device 37 are respectively assembled by elastic snap-fitting onto the first and second arms 55a, 55b of the first holding device 37. In the same way, the first and second guide wheels 40a, 40b of the second holding device 39 are assembled respectively by elastic snap-fitting onto the first and second arms 56a, 56b of the second holding device 39.

Advantageously, the respective first switching mechanism 41 or second switching mechanism 42 comprises at least one button 62.

Advantageously, each button 62 is accessible at a wall 63 of the housing 43, in particular by a user.

Here and as illustrated in FIG. 6, each button 62 is arranged through an opening 64 provided in the wall 63 of the housing 43. Only one opening 64 is visible in FIG. 6, the other opening being symmetrical to that visible in this figure relative to the median plane P.

Here, the motorized drive device 10 comprises two buttons 62. In such a case, the two buttons 62 are, preferably, arranged on two opposite sides of the housing 43.

Advantageously, the respective first button 62 or second button 62 is configured to switch the respective first switching mechanism 41 or second switching mechanism 42, between its first position and its second position.

Thus, when the first and second buttons 62 are actuated, the first and second switching mechanisms 41, 42 drive the first guide wheel 38a, 40a of the respective first holding device 37 or second holding device 39, relative to the second guide wheel 38b, 40b, between their first position and their second position.

In this way, after actuation of the first and second buttons 62, the first guide wheel 38a, 40a of the respective first holding device 37 or second holding device 39 is positioned opposite the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

As a result, the insertion or extraction of the first and second guide wheels 38a, 38b, 40a, 40b of the first and second holding devices 37, 39 into or from the rail 4 is implemented by aligning the first guide wheel 38a, 40a of the respective first holding device 37 or second holding device 39, along the direction of movement D of the motorized drive device 10 along the rail 4, with the second guide wheel 38b, 40b of the respective first holding device 37 or second holding device 39, by pressing the first and second buttons 62, in particular by means of two fingers of the same hand of the user.

Furthermore, when the first and second buttons 62 are pressed, the first and second switching mechanisms 41, 42 move, in particular along the translational movement M, the drive wheel 13 towards the interior of the housing 43 and, more particularly, the drive unit 49 towards the interior of the housing 43.

In this way, upon actuation of the first and second buttons 62, the first elastic return elements 44 are compressed, so as to prevent the drive wheel 13 from bearing against the running surface 14 of the rail 4.

Moreover, when the first and second buttons 62 are released, the first and second switching mechanisms 41, 42 drive the first and second guide wheels 38a, 38b, 40a, 40b of the respective first holding device 37 or second holding device 39, between their second and first positions.

In this way, upon release of the first and second buttons 62, the second guide wheel 38b, 40b of the respective first holding device 37 or second holding device 39 becomes offset again, in the transverse direction D′, relative to the first guide wheel 38a, 40a of the respective first holding device 37 or second holding device 39, so that the first and second guide wheels 38a, 38b, 40a, 40b of the respective first holding device 37 or second holding device 39 come into contact with the first and second tracks 8a, 8b of the rail 4.

Furthermore, when the first and second buttons 62 are released, the first and second switching mechanisms 41, 42 move, in particular along the translational movement M, the drive wheel 13 outwards from the housing 43 and, more particularly, the drive unit 49 outwards from the housing 43.

In this way, when the first and second buttons 62 are released, the first elastic return elements 44 relax, so as to support the drive wheel 13 on the running surface 14 of the rail 4.

Advantageously, the first button 62 of the respective first switching mechanism 41 or the second button 62 of the second switching mechanism 42 is rotatably mounted, about an axis of rotation X62, relative to the chassis 45 and, more particularly, relative to the respective first branch 53 of the chassis 45 or second branch 54 of the chassis 45, as illustrated in FIGS. 9 to 11.

Here and as illustrated in FIG. 9, the rotational movement of the respective first button 62 of the first switching mechanism 41 or second button 62 of the second switching mechanism 42 is implemented by means of a rotation shaft 65 inserted, on one hand, into at least one opening 66 of the respective first button 62 of the first switching mechanism 41 or second switching mechanism 42, and, on the other hand, into at least one opening 67 of the chassis 45 and, more particularly, of the respective first branch 53 of the chassis 45 or the second branch 54 of the chassis 45.

Here, the respective first button 62 of the first switching mechanism 41 or the second button 62 of the second switching mechanism 42 comprises two openings 66. Furthermore, the chassis 45, in particular the first branch 53 of the chassis 45 and the second branch 54 of the chassis 45, comprises two openings 67 configured to interact with a rotation shaft 65 inserted in the two openings 66 of the first button 62 of the first switching mechanism 41 and two openings 67 configured to interact with a rotation shaft 65 inserted in the two openings 66 of the second button 62 of the second switching mechanism 42.

Advantageously, the translational movement M of the drive wheel 13 relative to the housing 43, when the first and second buttons 62 are actuated or released, is implemented by means of a cam 68 related to each of the first and second buttons 62, the cam 68 of each of the first and second buttons 62 being configured to interact with a pin 69 of the casing 50 of the drive unit 49, as illustrated in FIGS. 10 to 12. The cam 68 related to each of the first and second buttons 62 has been omitted in FIGS. 6, 7 and 9, for ease of reading.

Here and as illustrated in FIGS. 10 through 12, the cam 68 of each of the first and second buttons 62 comprises a ramp 70. Furthermore, this ramp 70 is configured to interact with a pin 69 of the casing 50 of the drive unit 49, in the assembled configuration of the motorized drive device 10.

Advantageously, the motorized drive device 10 further comprises at least a second elastic return element 71.

Here and as illustrated in FIGS. 9 to 11, the motorized drive device 10 includes two second elastic return elements 71. Furthermore, each of the second elastic return elements 71 is configured to interact, in other words interacts, with one of the first and second switching mechanisms 41, 42, in the assembled configuration of the motorized drive device 10.

Here, each second elastic return element 71 is a spring, in particular a compression spring, and is formed as a spiral.

The number and shape of the second elastic return elements are not limiting and may be different. The number of second elastic return elements may be one, three or more. Furthermore, the or each second elastic return element may be a tension spring and may be made as a pin or may be a leaf spring.

Furthermore, one of the two second elastic return elements 71 is configured to tilt the respective first switching mechanism 41 or second switching mechanism 42 into an initial position, so as to drive the first guide wheel 38a, 40a of the respective first holding device 37 or second holding device 39, relative to the second guide wheel 38b, 40b of the respective first holding device 37 or second holding device 39, between its second position and its first position.

Advantageously, one of the two second elastic return elements 71 is configured to move the respective first button 62 or second button 62 to an initial position, called a rest position, by means of the first arm 55a, 56a.

Advantageously, when the first and second buttons 62 are actuated, the first and second switching mechanisms 41, 42 move the drive wheel 13 towards the interior of the housing 43 and, more particularly, the drive unit 49 towards the interior of the housing 43, then the first guide wheel 38a, 40a of the respective first holding device 37 or second holding device 39 is positioned opposite the second guide wheel 38b, 40b of the respective first holding device 37 or second holding device 39, so that the first and second guide wheels 38a, 38b, 40a, 40b can be inserted into or extracted from the rail 4, through the slot 5 of the rail 4.

Thus, this succession of movements, in a first step, of the drive wheel 13 and, more particularly, of the drive unit 49 and, in a second step, of the first and second guide wheels 38a, 38b, 40a, 40b of the respective first holding device 37 or second holding device 39, upon actuation of the first and second buttons 62, facilitates the insertion of the first and second guide wheels 38a, 38b, 40a, 40b of the respective first holding device 37 or second holding device 39 into the rail 4, through the slot 5 of the rail 4.

In this way, the insertion of the first and second guide wheels 38a, 38b, 40a, 40b of the respective first holding device 37 or second holding device 39 into the rail 4, through the slot 5 of the rail 4, can be implemented without exerting any force, in particular by the user, on the rail 4.

As a result, the insertion of the first and second guide wheels 38a, 38b, 40a, 40b of the respective first holding device 37 or second holding device 39 into the rail 4, through the slot 5 of the rail 4, can be implemented without having to press the drive wheel 13 against the rail 4 beforehand, in particular by the user.

Here, one of the two second elastic return elements 71 is configured to be mounted around the rotation shaft X62 of the first button 62 of the first switching mechanism 41 relative to the chassis 45, in particular the first branch 53 of the chassis 45, respectively around the rotation shaft X62 of the second button 62 of the second switching mechanism 42 relative to the chassis 45, in particular the second branch 54 of the chassis 45.

Advantageously, the first and second guide wheels 38a, 38b, 40a, 40b of the respective first holding device 37 or second holding device 39 have a respective diameter Ø, as illustrated in FIG. 10, greater than the width L of the slot 5 of the rail 4.

Thus, such a dimension of the first and second guide wheels 38a, 38b, 40a, 40b of the respective first holding device 37 or second holding device 39 makes it possible to improve an efficiency of the motorized driving device 10, during the electrical activation of the electric motor 11.

Furthermore, such a configuration of the motorized drive device 10 makes it possible to adapt the dimensions of the first and second guide wheels 38a, 38b, 40a, 40b of the respective first holding device 37 or second holding device 39, according to the dimensions of the rail 4.

Here and as illustrated in FIGS. 10 to 12, the diameter Ø of the first and second guide wheels 38a, 38b, 40a, 40b of the respective first holding device 37 or second holding device 39 is identical.

Here, the diameter Ø of the first and second guide wheels 38a, 38b, 40a, 40b of the respective first holding device 37 or second holding device 39 is smaller than a height H of the recess 6 of the rail 4, in other words a distance between the top wall 4a and the bottom wall 4b of the rail 4, as illustrated in FIG. 5.

Advantageously, the battery 12 is configured to be mounted, in other words is mounted, inside the housing 43, in particular at the bottom area of the housing 43, in the assembled configuration of the motorized drive device 10.

Here, in the assembled configuration of the motorized drive device 10, the battery 12 is supported against the wall 63 of the housing 43. Furthermore, the support wall 52 is supported against the battery 12.

When the electric motor 11 is electrically activated, the casing 50 is configured to be tilted within the housing 43, relative to the median plane P of the housing 43, as illustrated in FIG. 12.

In the first position of the first and second switching mechanisms 41, 42 and when the electric motor 11 is electrically activated, in particular in the assembled configuration of the occultation device 3, the drive wheel 13 is supported on the running surface 14 of the rail 4, by means of the first elastic return elements 44 which are supported on the support wall 52 arranged, in other words provided, in the housing 43 and is rotated, about the axis of rotation X13, by means of the electric motor 11 and, eventually, by means of the transmission device 28.

Thus, a compression force is exerted on the first elastic return elements 44 causing a movement of the drive unit 49 inside the housing 43. This movement of the drive unit 49 inside the housing 43 is dependent on the direction of rotation of the electric motor 11 and, thus, of the drive wheel 13.

In this way, the drive unit 49 is in an inclined position inside the housing 43 and, more particularly, relative to the rail 4.

As a result, an arching motion is generated within the motorized drive device 10 causing an increase in the force of the drive wheel 13 on the running surface 14 of the rail 4, so as to move the motorized drive device 10 along the rail 4.

Here, the stop 60 of the first arm 55a, 56a of the respective first holding device 37 or second holding device 39 is moved and then supported on a ramp 72 of the respective first switching mechanism 41 or second switching mechanism 42, only one of which is visible in FIG. 9.

Advantageously, the casing 50 comprises a first pin 73 and a second pin 74. Furthermore, when the electric motor 11 is electrically activated, the first pin 73 or the second pin 74 of the casing 50 is supported against a shoulder 75, 76 of the housing 43, depending on the direction of rotation of the electric motor 11.

Thus, the bearing of the first or second pin 73, 74 of the casing 50 with the shoulder 75, 76 of the housing 43 makes it possible, on one hand, to limit the inclination of the casing 50 relative to the housing 43 and, on the other hand, to guarantee a minimum pressure force of the drive wheel 13 on the running surface 14 of the rail 4, so as to avoid the drive wheel 13 slipping on the running surface 14 of the rail 4, when the electric motor 11 is electrically activated.

Here, each shoulder 75, 76 of the housing 43 is formed by a receding corner of the housing 43, in other words by two walls of the housing 43 forming a stop for the first or second pin 73, 74 of the casing 50.

Advantageously, when the electric motor 11 is electrically deactivated, the drive unit 49 may be in a position where a median plane of this drive unit 49 is parallel to the median plane P of the housing 43, in practice superimposed on the median plane P, as illustrated in FIG. 10.

In a variant, not shown, when the electric motor 11 is electrically deactivated, the drive unit 49 may remain in an inclined position relative to the median plane P of the housing 43, in particular due to the force of the drive wheel 13 on the running surface 14 of the rail 4, in the assembled configuration of the occultation device 3, and following a movement of the motorized drive device 10 along the rail 4.

In the assembled configuration of the occultation device 3, in the first position of the first and second switching mechanisms 41, 42 and when the electric motor 11 is electrically deactivated, the drive wheel 13 is supported on the running surface 14 of the rail 4, by means of the first elastic return elements 44 bearing on the wall 63 of the housing 43 and, more particularly, on the support wall 52.

Thus, a force is exerted in a balanced way on the first elastic return elements 44. This force is transmitted to the wall 63 of the housing 43 and then transmitted to the first and second guide wheels 38a, 38b, 40a, 40b of the respective first holding device 37 or second holding device 39, which themselves transmit this force to the rail 4, at the first and second running tracks 8a, 8b of the rail 4.

In this way, the drive unit 49 is in a vertical position inside the housing 43 and, more particularly, relative to the rail 4 which, by hypothesis, is horizontal.

Furthermore, in this case, the axis of rotation X55a of the first arm 55a of the first holding device 37 relative to the first branch 53 of the chassis 45 and the axis of rotation X56a of the first arm 56a of the second holding device 39 relative to the second branch 54 of the chassis 45 are arranged in a plane parallel to the running surface 14 of the rail 4.

Moreover, the stop 60 of the first arm 55a, 56a of the first and second holding devices 37, 39 is not supported with an edge of the opening 61 of one of the first and second branches 53, 54 of the chassis 45.

Advantageously, in the assembled configuration of the occultation device 3, the housing 43 of the motorized drive device 10 is configured to be held, in other words is held, in a static position relative to the rail 4 by means of the first and second holding devices 37, 39. In other words, the housing 43 cannot pivot about an axis of rotation, in particular an axis of rotation of one of the guide wheels 38a, 38b, 40a, 40b.

Thus, this static position of the housing 43 of the motorized drive device 10 relative to the rail 4 is implemented as a result of the motorized drive device 10 being held relative to the rail 4 by means of the first and second guide wheels 38a, 38b, 40a, 40b of the first and second holding devices 37, 39 interacting with the first and second running tracks 8a, 8b of the rail 4, whether during electrical activation or deactivation of the electric motor 11.

In this way, an angle value, not shown, between the median plane P of the housing 43 of the motorized drive device 10 relative to the bottom wall 4b of the rail 4 is constant, whether when the motorized drive device 10 is stopped relative to the rail 4 or when the motorized drive device 10 is moved along the rail 4, implemented by the electrical activation of the electric motor 11.

As a result, the housing 43 of the motorized drive device 10 is assembled relative to the rail 4 by means of a sliding connection.

Preferably, the value of the angle between the median plane P of the housing 43 of the motorized drive device 10 relative to the bottom wall 4b of the rail 4 is about 90°.

Such a construction of the motorized drive device 10 makes it possible to minimize a value of the stiffness of the or each first elastic return element 44.

Following the motorized drive device 10 being held relative to the rail 4 by means of the first and second holding devices 37, 39, the value of the stiffness of the first elastic return element(s) 44 determines an initial contact pressure of the drive wheel 13 on the running surface 14 of the rail 4, as long as the electric motor 11 is electrically deactivated.

Thanks to the present invention, the motorized drive device makes it possible to facilitate mounting the motorized drive device relative to a rail, while ensuring a minimum pressure force of a drive wheel on a running surface of the rail, so as to avoid the drive wheel slipping on the running surface of the rail, when the electric motor is electrically activated, and an adaptation of this pressure force, depending on a mass of a screen of the occultation or solar protection device pulled by the motorized drive device, so as to optimize an efficiency of the motorized drive device.

In this way, such a motorized drive device makes it possible to dispense with an additional pressure device of the drive wheel on the running surface of the rail arranged outside the housing.

Numerous modifications can be made to the above-described embodiments without departing from the scope of the invention defined by the claims.

In a variant, not shown, each of the first and second holding devices 37, 39 comprises a single first guide wheel 38a, 40a, each of which first guide wheels 38a, 40a is configured to be supported on the first track 8a of the rail 4.

In a variant, not shown, the motorized drive device 10 comprises only the first switching mechanism 41. Furthermore, the motorized drive device 10 is equipped with only one button 62. In such a case, the first switching mechanism 41 may be configured to interact with the first and second holding devices 37, 39 or only with the first holding device 37.

In a variant, not shown, the rail 4 may be, for example, circular in cross-section truncated by a flat spot, in particular at its lower side. In such a case, the flat spot of the rail 4 comprises the slot 5 and forms the first and second running tracks 8a, 8b, as well as the running surface 14.

In a variant, not shown, the rail 4 may be, for example, circular in cross section, in particular solid or hollow. Here, the rail 4 is more commonly referred to as a round rod or round bar. Moreover, the rail 4 is without the slot 5. In such a case, the respective first guide wheel 38a of the first holding device 37 or the first guide wheel 40a of the second holding device 39 is configured to be supported on the first running track 8a of the rail 4. Furthermore, the first running track 8a of the rail 4 is located at an upper side of the rail 4 and the running surface 14 of the rail 4 is located at a lower side of the rail 4. Moreover, the respective first and second holding devices 37, 39 may be without a second guide wheel 38b, 40b.

In a variant, not shown, the screen 2 is without support elements 7, in particular when the rail 4 has a circular cross-section, which may be truncated by a flat spot. In such a case, the screen 2 comprises eyelets. Furthermore, the rail 4 is inserted through the eyelets of the screen 2, so as to suspend the screen 2 relative to the rail 4.

In a variant, not shown, in the case where the occultation device 3 comprises two screens 2 and a single rail 4, the occultation device 3 comprises two motorized drive devices 10. In the assembled configuration of the occultation device 3, a first motorized drive device 10 is configured to be held to the rail 4, in other words suspended from the rail 4, and is configured to move along the rail 4, so as to close or open a first screen 2. Furthermore, a second motorized drive device 10 is configured to be held to the rail 4, in other words suspended from the rail 4, and is configured to move along the rail 4, so as to close or open a second screen 2.

In a variant, not shown, the motorized drive device 10 further comprises a cam and a pin, the pin being configured to interact with a profile of the cam. In an assembled configuration of the motorized drive device 10, the cam is integral with the casing 50 of the drive unit 49 and the pin is integral with the housing 43 of the motorized drive device 10, or vice versa. When the electric motor 11 is electrically activated, a force is transmitted to the drive unit 49 and, as a result, to the drive wheel 13, by means of the pin and the cam.

Advantageously, the cam profile is determined to avoid the drive wheel 13 slipping relative to the running surface 14 of the rail 4, upon electrical activation of the electric motor 11.

Furthermore, the envisaged embodiments and variants may be combined to generate new embodiments of the invention, without departing from the scope of the invention defined by the claims.

1. A motorized drive device of an occultation or solar protection device, the motorized drive device being provided for moving at least one screen along a rail of the occultation or solar protection device according to a sliding movement, the motorized drive device comprising at least:
a housing,
an electric motor,
a drive wheel, the drive wheel being configured to be rotated by means of the electric motor and to be supported on at least one running surface of the rail, so as to move the motorized drive device along the rail in a direction of movement,
a first holding device, the first holding device comprising at least a first guide wheel, the first guide wheel being configured to be supported on a first running track of the rail,
a second holding device, the second holding device comprising at least a first guide wheel, the first guide wheel being configured to be supported on the first running track of the rail,
a first elastic return element, and
a drive unit, the drive unit being configured to be housed within the housing, in an assembled configuration of the motorized drive device,
the drive unit comprising at least:
a casing,
the electric motor, and
the drive wheel,
the first elastic return element being configured to interact, both with the housing and also with the casing,
the drive wheel being configured to be supported on the running surface of the rail, by means of the first elastic return element-44 in an assembled configuration of the occultation device,
the casing being configured to be inclined inside the housing, relative to a median plane of the housing, when the electric motor is electrically activated,
wherein the motorized drive device further comprises at least:
a first switching mechanism, the first switching mechanism being configured to drive at least the first guide wheel of the first holding device between a first position and a second position, and vice versa,
wherein the first position of the first guide wheel of the first holding device is a position in which the motorized drive device is configured to be mounted relative to the rail,
wherein the second position of the first guide wheel of the first holding device is a position in which the motorized drive device is configured to be dismounted relative to the rail,
and wherein, in the first position of the first switching mechanism and when the electric motor is electrically activated, the drive wheel is supported on the running surface of the rail, by means of the first elastic return element supported on a wall support arranged in the housing and is rotated, about the axis of rotation, by means of the electric motor.

2. The motorized drive device of an occultation or solar protection device according to claim 1, wherein the casing comprises a first pin and a second pin and wherein, when the electric motor is electrically activated, the first pin or the second pin of the casing is supported against a shoulder of the housing, depending on the direction of rotation of the electric motor.

3. The motorized drive device of an occultation or solar protection device according to claim 1, wherein the first and second holding devices are connected to the housing by means of a chassis.

4. The motorized drive device of an occultation or solar protection device according to claim 1, wherein the motorized drive device further comprises at least:
a second switching mechanism, the second switching mechanism being configured to drive at least the first guide wheel of the second holding device between a first position and a second position, and vice versa.

5. The motorized device of an occultation or solar protection device according to claim 1, wherein:
the first holding device further comprises a second guide wheel, the second guide wheel being configured to be supported with a second track of the rail, and
the second holding device further comprises a second guide wheel, the second guide wheel being configured to be supported with the second track of the rail.

6. The motorized drive device of an occultation or solar protection device according to claim 5, wherein the second guide wheel of the respective first holding device or second holding device is fixed relative to the housing of the motorized drive device.

7. An occultation or solar protection device comprising at least:
a screen,
a rail, and
a motorized drive device according to claim 1, the screen being suspended from the rail and being movable along the rail, by means of the motorized drive device.

8. The occultation or solar protection device according to claim 7, wherein the first guide wheels are configured to be inserted into or extracted from the rail, through a slot of the rail, so as to hold or detach the motorized drive device relative to the rail.

9. The occultation or solar protection device according to claim 8, wherein:
the first holding device further comprises a second guide wheel, the second guide wheel being configured to be supported with a second track of the rail, and
the second holding device further comprises a second guide wheel, the second guide wheel being configured to be supported with the second track of the rail,
and wherein the second guide wheels are configured to be inserted into or extracted from the rail, through the slot of the rail, so as to hold or detach the motorized drive device relative to the rail.

10. The occultation or solar protection device according to claim 9, wherein the motorized drive device further comprises at least:
a second switching mechanism, the second switching mechanism being configured to drive at least the first guide wheel of the second holding device between a first position and a second position, and vice versa,
and wherein:
in a first position of the respective first switching mechanism or second switching mechanism, the first guide wheel of the respective first holding device or second holding device is offset relative to the second guide wheel of the respective first holding device or second holding device, so that the motorized drive device is held relative to the rail by the first and second guide wheels respectively supported on the first and second tracks of the rail, and
in a second position of the first switching mechanism or of the second switching mechanism, the first guide wheel of the respective first holding device or of the second holding device is positioned opposite, in the direction of movement of the motor drive, the second guide wheel of the respective first holding device or of the second holding device, along the rail, so as to insert or extract the first and second guide wheels into or from the rail, through the slot of the rail.

11. A home automation installation, wherein said installation comprises an occultation or solar protection device according to claim 7.

12. The motorized drive device of an occultation or solar protection device according to claim 2, wherein the first and second holding devices are connected to the housing by means of a chassis.

13. The motorized drive device of an occultation or solar protection device according to claim 2, wherein the motorized drive device further comprises at least:
a second switching mechanism, the second switching mechanism being configured to drive at least the first guide wheel of the second holding device between a first position and a second position, and vice versa.

14. The motorized drive device of an occultation or solar protection device according to claim 3, wherein the motorized drive device further comprises at least:
a second switching mechanism, the second switching mechanism being configured to drive at least the first guide wheel of the second holding device between a first position and a second position, and vice versa.

15. The motorized device of an occultation or solar protection device according to claim 2, wherein:
the first holding device further comprises a second guide wheel, the second guide wheel being configured to be supported with a second track of the rail, and
the second holding device further comprises a second guide wheel, the second guide wheel being configured to be supported with the second track of the rail.

16. The motorized device of an occultation or solar protection device according to claim 3, wherein:
the first holding device further comprises a second guide wheel, the second guide wheel being configured to be supported with a second track of the rail, and
the second holding device further comprises a second guide wheel, the second guide wheel being configured to be supported with the second track of the rail.

17. The motorized device of an occultation or solar protection device according to claim 4, wherein:
the first holding device further comprises a second guide wheel, the second guide wheel being configured to be supported with a second track of the rail, and
the second holding device further comprises a second guide wheel, the second guide wheel being configured to be supported with the second track of the rail.

18. An occultation or solar protection device comprising at least:
a screen,
a rail, and
a motorized drive device according to claim 2, the screen being suspended from the rail and being movable along the rail, by means of the motorized drive device.

19. An occultation or solar protection device comprising at least:
a screen,
a rail, and
a motorized drive device according to claim 3, the screen being suspended from the rail and being movable along the rail, by means of the motorized drive device.

20. An occultation or solar protection device comprising at least:
a screen,
a rail, and
a motorized drive device according to claim 4, the screen being suspended from the rail and being movable along the rail, by means of the motorized drive device.
